(19) United States
(12) Patent Application Publication
(10) Pub. No.: US 2021/0328502 A1
(43) Pub. Date: Oct. 21, 2021

(54) POWER CONVERTER CONTROLLER WITH SHORT-CIRCUIT PROTECTION

(71) Applicant: INNO-TECH CO., LTD., Taipei City (TW)

(72) Inventors: Chin-Chuan Chen, Taipei City (TW); Shu-Chia Lin, Taipei City (TW); Chih-Liang Wang, Taipei City (TW)

(21) Appl. No.: 16/993,349

(22) Filed: Aug. 14, 2020

(30) Foreign Application Priority Data
Apr. 17, 2020 (TW) 109113106

(51) Int. Cl. H02M 1/32; H02M 3/335; H02M 1/08

(52) U.S. Cl. CPC H02M 1/32; H02M 2001/0009; H02M 1/08; H02M 3/33507

(57) ABSTRACT

The present invention discloses a power converter controller with short-circuit protection employing a short-circuit protection increasing slope threshold no higher than an over-current protection increasing slope threshold to detect a short-circuit abnormality in advance through a current sensing pin while any semiconductor component suffering from abnormal voltage or over-current, thereby preventing the semiconductor components from damage.

### CROSS-REFERENCE TO RELATED APPLICATION

This application claims the priority of Taiwanese patent application No. 109113106, filed on Apr. 17, 2020, which is incorporated herewith by reference.

### BACKGROUND OF THE INVENTION

### 1. Field of the Invention

The present invention generally relates to a power converter controller, and more specifically to a power converter controller with short-circuit protection having a short-circuit protection increasing slope threshold no higher than an over-current protection increasing slope threshold to achieve power conversion and exclude noise interference, and implement short-circuit protection, and over-current protection, thereby detecting short-circuit and over-current abnormalities in advance, and preventing semiconductor components and electronic elements from damage due to abnormal voltage or over-current.

### 2. The Prior Arts

As well known, the pulse width modulation (PWM) scheme is one of the most widely used for the switching power supply in the prior arts, and a specific integrated circuit (IC) to implement PWM feature is usually called PWM IC. In general, the PWM IC does not only control the output voltage and current of the power supply, but is also provided with appropriate protection mechanism to avoid serious risk like fire and electric shock due to incorrect use or abnormality, which even leads to damage the overall system. The traditional protection mechanism of the PWM IC at least includes protection of over-current, short-circuit, over-voltage, over-temperature, and so on.

The PWM IC in the prior arts usually employs a feedback (FB) pin and a current sensing (CS) pin. The FB pin is considered as a compensation pin or an input terminal for detecting the secondary side loading level, and the CS pin is considered as an input terminal for sensing and detecting the primary side peak current to implement PWM control of peak current mode.

Further, the PWM IC has to detect over-current and short-circuit current, and in addition to the PWM comparator, the PWM IC is usually built with two comparators, which are called over-loading threshold (Limit1) comparator and short-circuit threshold (Limit2) comparator, respectively.

The Limit1 comparator is intended for maximum current detection. When output over-loading occurs, the peak current of the CS pin increases to exceed the over-current protection threshold voltage. At this time, the Limit1 comparator is triggered, and the PWM IC waits a period of delay time and then stops output to achieve over-current protection.

When the output short-circuit or much heavier loading occurs, the peak current of the CS pin increases to exceed the short-circuit protection threshold voltage. At this time, the Limit2 comparator is triggered, and the PWM IC immediately stops output to assure that the power supply is not damaged.

One of the most commonly recognized and used schemes is that the short-circuit protection threshold voltage is set to be higher than the over-current protection threshold voltage. It is because the primary side current is considerable high while short circuit occurs, and the current sensing voltage of the CS pin is high enough to trigger the Limit2 comparator, thereby immediately stopping the output power. Furthermore, another reason for the short-circuit protection threshold voltage higher than the over-current protection threshold voltage is to avoid malfunction due to an extremely short period of over-current, causing the power supply to incorrectly stop the output power. In other words, the overall period of time when the current sensing voltage of the CS pin is greater than the short-circuit protection threshold voltage but less than the over-current protection threshold voltage is possibly very short and does not exceed the preset delay time (like during the moment of powering on), and the output power should not stop because this situation is tolerable for the design of the power supply, otherwise the system provided with the power supply certainly fails without power.

In general, the over-current protection threshold voltage is intended for over-current protection (OCP) as the threshold for the maximum input current peak, and usually called Max Current Limit, CS voltage damper, Current Limit Threshold Voltage, Limit Voltage, or Max CS threshold voltage. Further, the short-circuit protection threshold voltage is intended for short-circuit (SHORT) protection like output abnormality including short circuit of output terminal, transformer winding, or secondary rectification elements. Thus, the short-circuit protection threshold voltage is triggered for prompt protection. The short-circuit protection threshold voltage is usually called Short Protection Threshold Voltage, Diode short protection voltage, Secondary Diode Short Protection, Abnormal Overcurrent Fault Threshold, or Over-current Threshold.

For example, the controller chip currently used includes OB/OB2283IC, Richtek/RT7738IC, Leadtrend/LD5538I, ONSEMI/NCP1342, and TI/UCC28742, which are provided with the over-current protection threshold voltage and the short-circuit protection threshold voltage as 0.69V/1.4V, 0.40V/1.1V, 0.85V/1.5V, 0.80V/1.2V, and 0.77V/1.5V. It is obvious that the current schemes set the short-circuit protection threshold voltage to be higher than the over-current protection threshold voltage.

The drawback in the prior arts is that the short-circuit abnormality is determined to stop the output power only if the current sensing voltage from the CS pin increases to exceed the over-current protection threshold voltage and lasts for a period of time, and it thus fails to detect the short-circuit abnormality in advance. Specifically, all the components of the power supply suffer from voltage or current stress imposed by the primary current during the period of time, resulting in potential risk to cause the power supply to damage.

It is greatly needed to provide a new power converter controller with short-circuit protection employing a short-circuit protection increasing slope threshold no higher than an over-current protection increasing slope threshold to detect short-circuit abnormality in advance, effectively decrease voltage or current stress upon semiconductor components, dynamically adjust the leading edge blanking time, the first detecting time, the second detecting time, the third detecting time, and the fourth detecting time, avoid malfunction, and prevent the power supply from damage, thereby overcoming the above problems in the prior arts.

### SUMMARY OF THE INVENTION

The primary object of the present invention is to provide a power converter controller with short-circuit protection comprising an input power pin, a ground pin, a pulse width modulation (PWM) driving pin, a current sensing pin, and a feedback pin, and having an short-circuit protection leading edge blanking (LEB) time, an over-current protection leading edge blanking time, a short-circuit protection increasing slope threshold, and an over-current protection increasing slope threshold preset. The power converter controller is further in collocation with a rectification unit, a transformer, a switch unit, and a power output unit to perform a power control operation for converting an external input power into an output power to supply a load. In particular, the short-circuit protection increasing slope threshold is not higher than the over-current protection increasing slope threshold, and the over-current protection leading edge blanking time is greater than the short-circuit protection leading edge blanking time.

Specifically, the input power pin is connected to an input power, the ground pin is connected to a ground level, the PWM driving pin is connected to a gate of the switch unit, the current sensing pin is connected to a source of the switch unit, and the source is further connected to the ground level through a current sensing resistor. The current sensing resistor generates a current sensing voltage. In addition, the feedback pin is connected to a feedback unit, and the feedback unit is further connected to the power output unit for generating a feedback voltage corresponding to the output power.

Additionally, the rectification unit receives and converts the external input power into a rectification power. The transformer comprises a primary winding and a secondary winding, the primary winding connects the rectification unit to a drain of the switch unit and receives the rectification power, the secondary winding is connected to the power output unit, and the power output unit is further connected to the load,

More specifically, the power control operation comprises the steps as described below.

First, the power converter controller receives the feedback voltage and the current sensing voltage, and generates a PWM driving signal based on the feedback voltage and the current sensing voltage. The PWM driving signal has a turn-on level and a turn-off level, which interleave and repeat periodically. The period of time for the turn-on level is called turn-on time.

Then, when the PWM driving signal is the turn-on level and the switch unit is turned on, a first rising slope and a second rising slope of the current sensing voltage at a first detecting time and a second detecting time are calculated, respectively. The second detecting time is greater than the first detecting time, and the first detecting time and the second detecting time are less than the turn-on time. In particular, the first detecting time is less than the short-circuit protection leading edge blanking time, the second detecting time is equal to the short-circuit protection leading edge blanking time, or between the short-circuit protection leading edge blanking time and the over-current protection leading edge blanking time.

The first rising slope and the second rising slope are used to determine whether noise interference occurs or not.

If the first rising slope is equal to or greater than the short-circuit protection increasing slope threshold, and the second rising slope decreases and is less than the short-circuit protection increasing slope threshold, it is confirmed that noise interference happens, and an exclusion operation for noise interference is performed to continue generating the PWM driving signal.

If the first rising slope and the second rising slope are equal to or greater than the short-circuit protection increasing slope threshold, it is confirmed that short-circuit abnormality occurs, and a short-circuit protection operation is performed to stop generating the PWM driving signal.

If no noise interference occurs and no short-circuit protection operation is performed, a third rising slope of the current sensing voltage at the third detecting time is calculated. The third detecting time is equal to the over-current protection leading edge blanking time, or between the over-current protection leading edge blanking time and the turn-on time. The second rising slope and the third rising slope are subsequently used to determine whether over-current abnormality occurs or not.

If the second rising slope and the third rising slope are equal to or greater than the over-current protection increasing slope threshold, it is confirmed that over-current abnormality occurs, and an over-current protection operation is performed to stop generating the PWM driving signal after an over-current delay time preset. If no over-current abnormality occurs, the PWM driving signal is continued as usual without change.

Furthermore, another object of the present invention is to provide a power converter controller with short-circuit protection having an short-circuit protection leading edge blanking (LEB) time, an over-current protection leading edge blanking time, a short-circuit protection increasing slope threshold, and an over-current protection increasing slope threshold preset, and comprising an input power pin, a ground pin, a PWM driving pin, and a current sensing pin. The power converter controller is further in collocation with a rectification unit, a transformer, a switch unit, and a power output unit to perform a power control operation for converting an external input power into an output power. In particular, the short-circuit protection increasing slope threshold is not higher than the over-current protection increasing slope threshold, and the over-current protection leading edge blanking time is greater than the short-circuit protection leading edge blanking time.

Additionally, the input power pin is connected to an input power, the ground pin is connected to a ground level, the PWM driving pin is connected to a gate of the switch unit, the current sensing pin is connected to a source of the switch unit, and the source is further connected to the ground level through a current sensing resistor. The current sensing resistor generates a current sensing voltage.

Specifically, the power control operation comprises the steps as described below.

First, the power converter controller receives t the current sensing voltage, and generates a PWM driving signal based on the current sensing voltage. The PWM driving signal has a turn-on level and a turn-off level, which interleave and repeat periodically. The period of time for the turn-on level is called turn-on time.

When the PWM driving signal is the turn-on level and the switch unit is turned on, a first rising slope and a second rising slope of the current sensing voltage at a first detecting time and a second detecting time are calculated, respectively. The second detecting time is greater than the first detecting time, and the first detecting time and the second detecting time are less than the turn-on time. In particular, the first detecting time is less than the short-circuit protection leading edge blanking time, the second detecting time is equal to the short-circuit protection leading edge blanking time, or between the short-circuit protection leading edge blanking time and the over-current protection leading edge blanking time.

The first rising slope and the second rising slope are used to determine whether noise interference occurs or not.

If the first rising slope is equal to or greater than the short-circuit protection increasing slope threshold, and the second rising slope decreases and is less than the short-circuit protection increasing slope threshold, it is confirmed that noise interference happens, and an exclusion operation for noise interference is performed to continue generating the PWM driving signal.

If the first rising slope and the second rising slope are equal to or greater than the short-circuit protection increasing slope threshold, it is confirmed that short-circuit abnormality occurs, and a short-circuit protection operation is performed to stop generating the PWM driving signal.

If no noise interference occurs and no short-circuit protection operation is performed, a third rising slope of the current sensing voltage at the third detecting time is calculated. The third detecting time is equal to the over-current protection leading edge blanking time, or between the over-current protection leading edge blanking time and the turn-on time. The second rising slope and the third rising slope are subsequently used to determine whether over-current abnormality occurs or not.

If the second rising slope and the third rising slope are equal to or greater than the over-current protection increasing slope threshold, it is confirmed that over-current abnormality occurs, and an over-current protection operation is performed to stop generating the PWM driving signal after an over-current delay time preset. If no over-current abnormality occurs, the PWM driving signal is continued as usual without change.

Since the short-circuit protection increasing slope threshold is no higher than the over-current protection increasing slope threshold, it is first examined whether the short-circuit abnormality occurs, and if no short-circuit abnormality happens, it is then examined whether the over-current abnormality occurs. The present invention is different from the tradition operation in the order of examining short-circuit and over-current, and able to detect the short-circuit abnormality in advance to effectively prevent the semiconductor components and the electronic elements from damage due to abnormal voltage or over-current. In particular, the leading edge blanking time, the first detecting time, the second detecting time, the third detecting time, and the fourth detecting time can be optimally adjusted at a time to avoid malfunction, prevent the power supply from damage, and assure safety of the whole operation of the system.

Therefore, the present invention does not only implement power conversion, but also excludes noise interference to perform short-circuit protection and over-current protection, particularly detecting the abnormality of short-circuit and over-current in advance and preventing semiconductor components and electronic elements from damage due to abnormal voltage or over-current.

### BRIEF DESCRIPTION OF THE DRAWINGS

The present invention can be understood in more detail by reading the subsequent detailed description in conjunction with the examples and references made to the accompanying drawings, wherein:

FIG. 1 is a flowchart of the power control operation performed by the power converter controller with short-circuit protection according to the first embodiment of the present invention;

FIG. 2 is a view showing the power converter controller according to the first embodiment of the present invention;

FIG. 3 is a view showing one illustrative waveform of the power converter controller according to the first embodiment of the present invention;

FIG. 4 is a flowchart of the power control operation performed by the power converter controller with short-circuit protection according to the second embodiment of the present invention; and

FIG. 5 is a view showing the power converter controller according to the second embodiment of the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

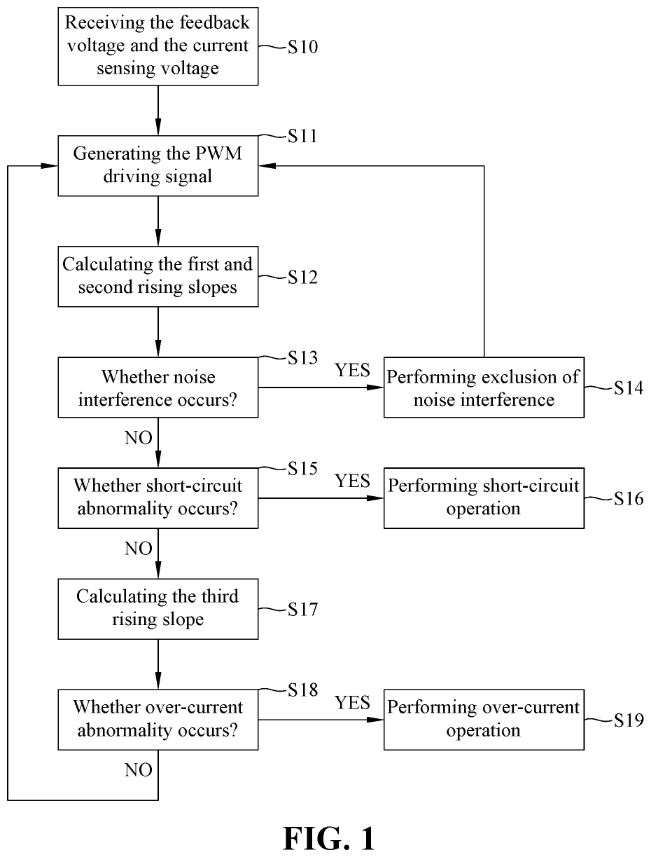

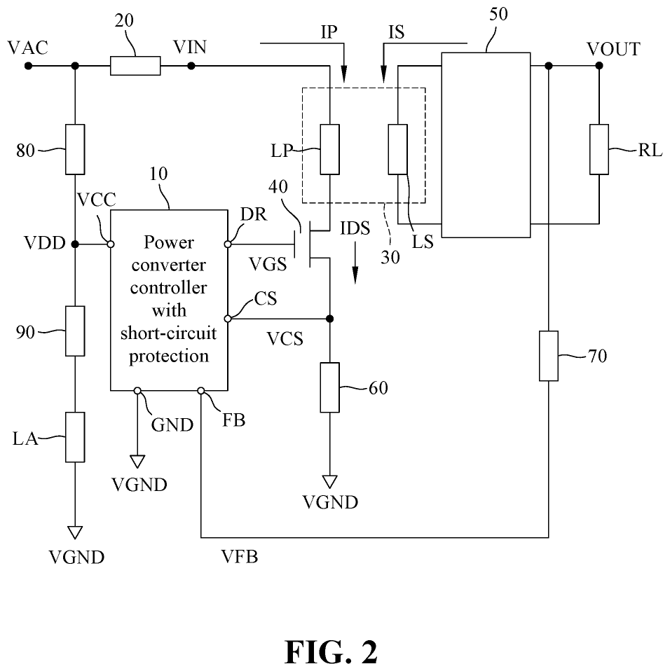

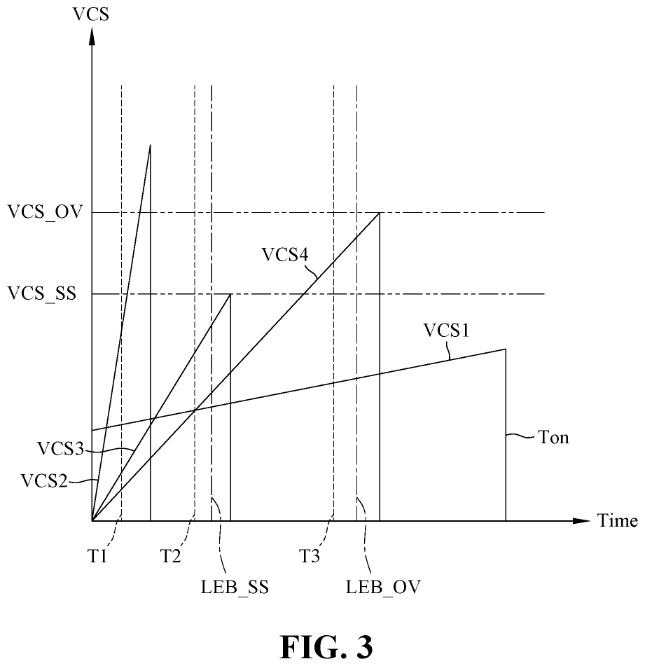

Please refer to FIGS. 1, 2, and 3. FIG. 1 is a flowchart of the power control operation performed by the power converter controller with short-circuit protection according to the first embodiment of the present invention, FIG. 2 is a view showing the power converter controller, and FIG. 3 is a view showing one illustrative waveform of the power converter controller.

As shown in FIGS. 1, 2, and 3, the power converter controller 10 with short-circuit protection according to the first embodiment of the present invention is substantially a pulse width modulation (PWM) controller and implemented by the semiconductor process for manufacturing integrated circuit (ICs). Specifically, the power converter controller 10 comprises an input power pin VCC, a ground pin GND, a pulse width modulation (PWM) driving pin DR, a current sensing pin CS, and a feedback pin FB, and has an short-circuit protection leading edge blanking (LEB) time LEB_SS, an over-current protection leading edge blanking time LEB_OV, a short-circuit protection increasing slope threshold, and an over-current protection increasing slope threshold preset. In particular, the power converter controller 10 is in collocation with a rectification unit 20, a transformer 30, a switch unit 40, and a power output unit 50 to perform a power control operation for converting an external input power VAC into an output power VOUT to supply a load RL.

More particularly, the above short-circuit protection increasing slope threshold is not less than the over-current protection increasing slope threshold, and the over-current protection leading edge blanking time LEB_OV is greater than the short-circuit protection leading edge blanking time LEB_SS. As shown in FIG. 3, the short-circuit protection increasing slope threshold is set as a short-circuit protection threshold voltage VCS_SS divided by the short-circuit protection leading edge blanking time LEB_SS, or simply represented by VCS_SS/LEB_SS, and the over-current protection increasing slope threshold is set as an over-current protection threshold voltage VCS_OV divided by the over-current protection leading edge blanking time LEB_OV, or simply represented by VCS_OV/LEB_OV. The short-circuit protection threshold voltage VCS_SS is not greater than the over-current protection threshold voltage VCS_OV, and specified by the current sensing voltage VCS corresponding to short-circuit abnormality like short circuit of output terminal, transformer winding, or secondary rectification elements. The over-current protection threshold voltage VCS_OV is specified by the current sensing voltage VCS corresponding to over-current abnormality, and indicates that the primary side current is too much.

It should be noted that the short-circuit protection threshold voltage VCS_SS and the over-current protection threshold voltage VCS_OV can be dynamically set and adjusted to meet the actual environment, and accordingly, the short-circuit protection increasing slope threshold and the over-current protection increasing slope threshold are set and adjusted.

Specifically, the input power pin VCC is connected to an input power VDD, the ground pin GND is connected to a ground level VGND, the PWM driving pin DR is connected to a gate of the switch unit 40, the current sensing pin CS is connected to a source of the switch unit 40, and the source is further connected to the ground level VGND through a current sensing resistor 60. The current sensing resistor 60 generates a current sensing voltage VCS. In addition, the feedback pin FB is connected to a feedback unit 70, and the feedback unit 70 is further connected to the power output unit 50 for generating a feedback voltage VFB corresponding to the output power VOUT.

For example, the feedback unit 70 comprises a phot coupler.

Further, the rectification unit 20 receives and converts the external input power VAC into a rectification power VIN through a process of rectification, filter, and regulation.

The transformer 30 comprises a primary winding LP and a secondary winding LS, the primary winding LP connects the rectification unit 20 to a drain of the switch unit 40 and receives the rectification power VIN, the secondary winding LS is connected to the power output unit 50, and the power output unit 50 is further connected to the load RL.

One of the key aspects of the present invention is that the power control operation performed by the power converter controller 10 comprises the steps S10, S11, S12, S13, S14, S15, S16, S17, S18, and S19, which are performed sequentially. The present invention does not only implement power conversion, but also excludes noise interference, and performs short-circuit protection and over-current protection, particularly detecting the abnormality of short-circuit and over-current in advance and preventing semiconductor components and electronic elements from damage due to abnormal voltage or over-current.

First, the power control operation begins at the step S10, and the power converter controller 10 receives the feedback voltage VFB and the current sensing voltage VCS through the feedback pin FB and the current sensing pin CS, respectively. Then, the power converter controller 10 generates a PWM driving signal VGS based on the feedback voltage VFB and the current sensing voltage VCS in the step S11, and the PWM driving signal VGS has a turn-on level and a turn-off level, which interleave and repeat periodically. The period of time for the turn-on level is called turn-on time Ton. For instance, the turn-on level is a high level and the turn-off level is a low level lower than the high level, or alternatively, the turn-on level is a low level and the turn-off level is a high level higher than the high level.

Moreover, the switch unit 40 is implemented by a Metal-Oxide-Semiconductor (MOS) transistor, a Gallium Nitride field effect transistor (GaN FET), or a silicon carbide (SiC)-MOSFET.

In the step S12, when the PWM driving signal VGS is the turn-on level and the switch unit 40 is turned on, a first rising slope and a second rising slope of the current sensing voltage VCS at a first detecting time T1 and a second detecting time T2 are calculated, respectively. The second detecting time T2 is greater than the first detecting time T1, and the first detecting time T1 and the second detecting time T2 are less than the turn-on time Ton. In particular, the first detecting time T1 is less than the short-circuit protection leading edge blanking time LEB_SS, the second detecting time T2 is equal to the short-circuit protection leading edge blanking time LEB_SS, or between the short-circuit protection leading edge blanking time LEB_SS and the over-current protection leading edge blanking time LEB_OV.

Specifically, the first rising slope and the second rising slope of the current sensing voltage VCS are average slopes, In other words, the first rising slope is calculated in the way that the current sensing voltage VCS at the first detecting time T1 is divided by the first detecting time T1, and the second rising slope is calculated in the way that the current sensing voltage VCS at the second detecting time T2 is divided by the second detecting time T2. Or alternatively, the first rising slope and the second rising slope can be instantaneous slopes. It should be noted that the average slopes and the instantaneous slopes for the first rising slope and the second rising slope are all included in the scope of the present invention.

In the step S13, the first rising slope and the second rising slope are used to determine whether noise interference occurs or not. If noise interference occurs, the step S14 is performed, and if no noise interference occurs, the step S15 is performed.

Specifically, If the first rising slope is equal to or greater than the short-circuit protection increasing slope threshold, and the second rising slope decreases and is less than the short-circuit protection increasing slope threshold like zero, it is confirmed that noise interference happens, and an exclusion operation is performed in the step S14 to continue generating the PWM driving signal VGS. In other words, although the first rising slope of the current sensing voltage VCS is equal to or greater than the short-circuit protection increasing slope threshold, the second rising slope decreases and is less than the short-circuit protection increasing slope threshold like zero and such a case is just the instantaneous peak noise, instead of short-circuit abnormality.

In the step S15, the first rising slope and the second rising slope are further employed to determine whether any short-circuit abnormality occurs or not. If the short-circuit abnormality occurs, the step S16 is performed, and if no short-circuit abnormality occurs, the step S17 is performed.

Specifically, if the first rising slope and the second rising slope are equal to or greater than the short-circuit protection increasing slope threshold, it is confirmed that the short-circuit abnormality occurs, and a short-circuit protection operation in the step S16 is performed to immediately stop generating the PWM driving signal VGS. That is, only when the first rising slope and the second rising slope are equal to or greater than the short-circuit protection increasing slope threshold, such a case is the short-circuit abnormality.

In the step S17, a third rising slope of the current sensing voltage VCS at a third detecting time T3 is calculated. The third detecting time T3 is equal to the over-current protection leading edge blanking time LEB_OV, or between the over-current protection leading edge blanking time LEB_OV and the turn-on time Ton.

The step S18 is performed after the step S17, and the second rising slope and the third rising slope are subsequently used to determine whether any over-current abnormality occurs or not. If the over-current abnormality occurs, the step S19 is performed, and if no over-current abnormality occurs, the step S11 is performed to continue generating the PWM driving signal VGS.

Furthermore, if the second rising slope and the third rising slope are equal to or greater than the over-current protection increasing slope threshold, it is confirmed that the over-current abnormality occurs, and an over-current protection operation in the step S19 is performed to stop generating the PWM driving signal after an over-current delay time preset. If no over-current abnormality occurs, the PWM driving signal VGS is continued as usual without change. In other words, if the second rising slope is equal to or greater than the over-current protection increasing slope threshold, but the third rising slope is less than the over-current protection increasing slope threshold like zero, such as case is not over-current. Only when the second rising slope and the third rising slope are equal to or greater than the over-current protection increasing slope threshold, such as case is over-current, thereby avoiding malfunction.

Further refer to FIG. 3 showing one illustrative waveform of the power converter controller according to the first embodiment of the present invention. Specifically, four current sensing voltages VCS1, VCS2 VCS3, and VCS4 are employed as an illustrative example for the power converter controller of the first embodiment to describe the features and aspects achieved by the present invention employing the short-circuit protection increasing slope threshold and the over-current protection increasing slope threshold. The current sensing voltage VCS1 is normal, the current sensing voltage VCS2 is for noise interference, the current sensing voltage VCS3 is for short-circuit, and the current sensing voltage VCS4 is for over-current.

More specifically, the current sensing voltage VCS1 gradually increases up to a full loading called rated loading for the normal operation in the turn-on time Ton, and the full loading is less than the short-circuit protection threshold voltage VCS_SS no higher than the over-current protection threshold voltage VCS_OV. Thus, the current sensing voltage VCS1 indicates normal for operation without any abnormality. However, the short-circuit protection threshold voltage VCS_SS is shown to be less than the over-current protection threshold voltage VCS_OV in FIG. 3 as an example only for clear explaining the effect of the present invention. It should be noted that the short-circuit protection threshold voltage VCS_SS is required to be not greater than the over-current protection threshold voltage VCS_OV in the scope of the present invention.

In particular, the short-circuit protection increasing slope threshold and the over-current protection increasing slope threshold are specified to compare the first rising slope and the second rising slope calculated so as to determine in advance that the current sensing voltage VCS rises up equal to or greater than the short-circuit protection threshold voltage VCS_SS or the over-current protection threshold voltage VCS_OV.

It should be particularly noted that the first rising slope and the second rising slope of the present invention depend on the first detecting time T1 and the second detecting time T2. Thus, the first detecting time T1 and the second detecting time T2 are optimally according to actual environment while the short-circuit protection threshold voltage VCS_SS, the over-current protection threshold voltage VCS_OV, and the turn-on time Ton are not changed, thereby employing the first rising slope and the second rising slope to determine whether the current sensing voltage VCS rises up equal to or greater than the short-circuit protection threshold voltage VCS_SS and noise interference or short-circuit abnormality occurs.

In addition, the current sensing voltage VCS2 is considered an instantaneous noise just present before the short-circuit protection leading edge blanking time LEB_SS. That is, although the first rising slope at the first detecting time T1 is considerable high like greater than the short-circuit protection increasing slope threshold, and the peak value of the current sensing voltage VCS2 is usually far greater than the short-circuit protection threshold voltage VCS_SS, the current sensing voltage VCS2 then rapidly decreases and is less than the short-circuit protection threshold voltage VCS_SS like zero by the second detecting time T2 less than the short-circuit protection leading edge blanking time LEB_SS. Thus, the second rising slope also decreases below the short-circuit protection increasing slope threshold like zero, the influence of the current sensing voltage VCS2 is ignored, and the PWM driving signal VGS is generated without change, thereby implement exclusion of noise interference, and avoiding malfunction to incorrectly stop the PWM driving signal VGS.

Further, the first rising slope and the second rising slope of the current sensing voltage VCS3 are greater than the short-circuit protection increasing slope threshold, and the step S15 thus confirms that the short-circuit abnormality happens. The first rising slope, the second rising slope, and the third rising slope of the current sensing voltage VCS4 are less than the short-circuit protection increasing slope threshold but greater than the over-current protection increasing slope threshold, the step S18 confirms that the over-current abnormality happens.

Overall, the present invention can correctly identify that the current sensing voltage VCS1 is normal, the current sensing voltage VCS2 is for noise interference, the current sensing voltage VCS3 is for short-circuit, and the current sensing voltage VCS4 is for over-current.

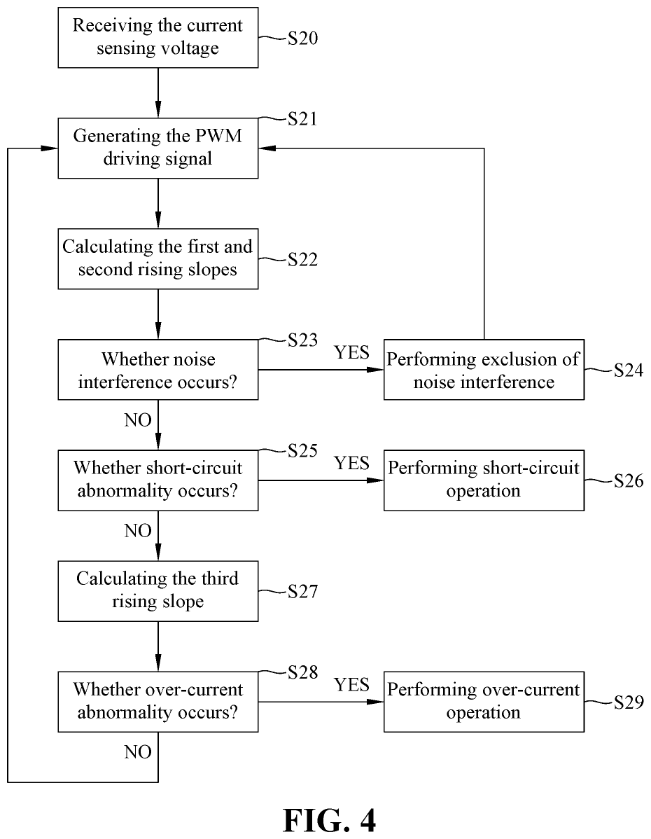

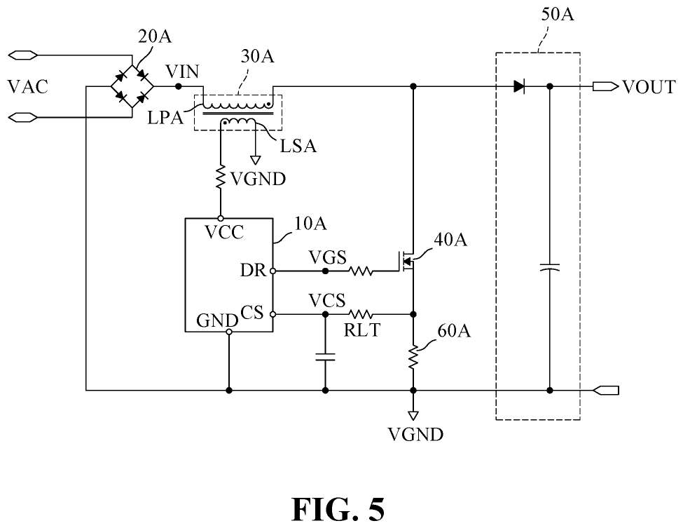

Further refer to FIGS. 4 and 5. FIG. 4 is a flowchart of the power control operation performed by the power converter controller with short-circuit protection according to the second embodiment of the present invention, and FIG. 5 is a view showing the power converter controller of the second embodiment.

As shown in FIGS. 4 and 5, the power converter controller 10A with short-circuit protection according to the second embodiment of the present invention is similar to the power converter controller 10 of the first embodiment, and accordingly has an short-circuit protection leading edge blanking time LEB_SS, an over-current protection leading edge blanking time LEB_OV, a short-circuit protection increasing slope threshold, and an over-current protection increasing slope threshold preset. However, the power converter controller 10A of the second embodiment does not includes the feedback pin but only comprises an input power pin VCC, a ground pin GND, a pulse width modulation (PWM) driving pin DR, and a current sensing pin CS.

Additionally, the power converter controller 10A of the second embodiment is in collocation with a rectification unit 20A, a transformer 30A, a switch unit 40A, and a power output unit 50A to perform a power control operation for converting an external input power VAC into an output power VOUT. Also, the current sensing pin CS is connected to a source of the switch unit 40A through a current limit resistor RLT, and the source is connected to a ground level VGND through a current sensing resistor 60A. The current sensing pin CS generates a current sensing voltage VCS.

Further, the transformer 30A comprises a primary winding LPA and a secondary winding LSA. The primary winding LPA connects the rectification unit 20A to a drain of the switch unit 40A, the drain is further connected to the power output unit 50A, and the secondary winding LSA is connected between the input power pin VCC and the ground level VGND. In addition, the rectification unit 20A receives and converts the external input power VAC into a rectification power VIN.

Specifically, the power control operation performed by the power converter controller 10A comprises the steps S20, S21, S22, S23, S24, S25, S26, S27, S28, and S29, which are performed sequentially and similar to the steps S10, S11, S12, S13, S14, S15, S16, S17, S18, and S19 of the first embodiment. One key difference is that the step S20 only receives the current sensing voltage VCS and the step S21 only uses the current sensing voltage VCS to generate the PWM driving signal VGS instead of the feedback voltage because the feedback unit is not employed in the second embodiment. Thus, the other steps S22, S23, S24, S25, S26, S27, S28, and S29 are not described hereinafter.

It should be noted that the power converter controller 10A of the second embodiment is in collocation with different circuit components and performs the steps S20, S21, S22, S23, S24, S25, S26, S27, S28, and S29 to implement the same function provided as that by the power converter controller 10 of the first embodiment performing the steps S10, S11, S12, S13, S14, S15, S16, S17, S18, and S19 so as to exclude noise interference, implement short-circuit protection, and over-current protection, and prevent the semiconductor components and the electronic elements from damage due to abnormal voltage or over-current.

From the above mention, the aspect of present invention is that the short-circuit protection increasing slope threshold no higher than the over-current protection increasing slope threshold preset are employed to detect noise interference, short-circuit, and over-current so as to detect any abnormal voltage or over current for the semiconductor components in advance through the current sensing voltage while the short-circuit abnormality occurs. Thus, the semiconductor components are prevented from damage. Further, the present invention can simultaneously adjust the short-circuit protection leading edge blanking time, the over-current protection leading edge blanking time, the first detecting time, the second detecting time, and the third detecting time to avoid incorrectly triggering, prevent the power supply from damage, and assure safety for the whole operation.

Therefore, the present invention does not only implement power conversion, but also excludes noise interference to perform short-circuit protection and over-current protection, particularly detecting the abnormality of short-circuit and over-current in advance and preventing semiconductor components and electronic elements from damage due to abnormal voltage or over-current.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power converter controller with short-circuit protection having an short-circuit protection leading edge blanking (LEB) time, an over-current protection leading edge blanking time, a short-circuit protection increasing slope threshold, and an over-current protection increasing slope threshold in collocation with a rectification unit, a transformer, a switch unit, and a power output unit to perform a power control operation for converting an external input power into an output power to supply a load, the power converter controller comprising:
an input power pin connected to an input power;
a ground pin connected to a ground level a pulse width modulation (PWM) driving pin connected to a gate of the switch unit;
a current sensing pin connected to a source of the switch unit, the source further connected to the ground level through a current sensing resistor, the current sensing resistor generating a current sensing voltage; and
a feedback pin connected to a feedback unit, the feedback unit further connected to the power output unit for generating a feedback voltage corresponding to the output power;
wherein the short-circuit protection leading edge blanking time is less than the over-current protection leading edge blanking time, the short-circuit protection increasing slope threshold is no less than the over-current protection increasing slope threshold, the rectification unit receives and converts the external input power into a rectification power, the transformer comprises a primary winding and a secondary winding, the primary winding connects the rectification unit to a drain of the switch unit and receives the rectification power, the secondary winding is connected to the power output unit, the power output unit is connected to the load, and the power control operation comprises:
the power converter controller receiving the feedback voltage and the current sensing voltage;
generating a PWM driving signal based on the feedback voltage and the current sensing voltage, the PWM driving signal having a turn-on level and a turn-off level interleaving and repeating periodically;
when the PWM driving signal is the turn-on level and the switch unit is turned on, a first rising slope and a second rising slope of the current sensing voltage at a first detecting time and a second detecting time are calculated, respectively, wherein the second detecting time is greater than the first detecting time, the first detecting time and the second detecting time are less than the turn-on time, the first detecting time is less than the short-circuit protection leading edge blanking time, and the second detecting time is equal to the short-circuit protection leading edge blanking time, or between the short-circuit protection leading edge blanking time and the over-current protection leading edge blanking time;
determining whether noise interference occurs or not according to the first rising slope and the second rising slope;
if the first rising slope is equal to or greater than the short-circuit protection increasing slope threshold, and the second rising slope decreases and is less than the short-circuit protection increasing slope threshold, it is confirmed that noise interference happens, and an exclusion operation for noise interference is performed to continue generating the PWM driving signal;
if the first rising slope and the second rising slope are equal to or greater than the short-circuit protection increasing slope threshold, it is confirmed that short-circuit abnormality occurs, and a short-circuit protection operation is performed to stop generating the PWM driving signal;
if no noise interference occurs and no short-circuit protection operation is performed, a third rising slope of the current sensing voltage at the third detecting time is calculated, wherein the third detecting time is equal to the over-current protection leading edge blanking time, or between the over-current protection leading edge blanking time and the turn-on time, the second rising slope and the third rising slope are subsequently used to determine whether over-current abnormality occurs or not;
if the second rising slope and the third rising slope are equal to or greater than the over-current protection increasing slope threshold, it is confirmed that over-current abnormality occurs, and an over-current protection operation is performed to stop generating the PWM driving signal after an over-current delay time preset; and
if no over-current abnormality occurs, the PWM driving signal is still generated.

2. The power converter controller as claimed in claim 1, wherein the turn-on level is a high level and the turn-off level is a low level lower than the high level.

3. The power converter controller as claimed in claim 1, wherein the turn-on level is a low level and the turn-off level is a high level higher than the high level

4. The power converter controller as claimed in claim 1, wherein the switch unit is implemented by a Metal-Oxide-Semiconductor (MOS) transistor, a Gallium Nitride field effect transistor (GaN FET), or a silicon carbide (SiC)-MOSFET.

5. The power converter controller as claimed in claim 1, wherein the feedback unit comprises a photo coupler.

6. A power converter controller with short-circuit protection having an short-circuit protection leading edge blanking (LEB) time, an over-current protection leading edge blanking time, a short-circuit protection increasing slope threshold, and an over-current protection increasing slope threshold in collocation with a rectification unit, a transformer, a switch unit, and a power output unit to perform a power control operation for converting an external input power into an output power to supply a load, the power converter controller comprising:
an input power pin connected to an input power;
a ground pin connected to a ground level a pulse width modulation (PWM) driving pin connected to a gate of the switch unit; and
a current sensing pin connected to a source of the switch unit, the source further connected to the ground level through a current sensing resistor, the current sensing resistor generating a current sensing voltage;
wherein the short-circuit protection leading edge blanking time is less than the over-current protection leading edge blanking time, the short-circuit protection increasing slope threshold is no less than the over-current protection increasing slope threshold, the rectification unit receives and converts the external input power into a rectification power, the transformer comprises a primary winding and a secondary winding, the primary winding connects the rectification unit to a drain of the switch unit and receives the rectification power, the secondary winding is connected to the power output unit, and the power control operation comprises:
the power converter controller receiving the current sensing voltage;
generating a PWM driving signal based on the current sensing voltage, the PWM driving signal having a turn-on level and a turn-off level interleaving and repeating periodically;
when the PWM driving signal is the turn-on level and the switch unit is turned on, a first rising slope and a second rising slope of the current sensing voltage at a first detecting time and a second detecting time are calculated, respectively, wherein the second detecting time is greater than the first detecting time, the first detecting time and the second detecting time are less than the turn-on time, the first detecting time is less than the short-circuit protection leading edge blanking time, and the second detecting time is equal to the short-circuit protection leading edge blanking time, or between the short-circuit protection leading edge blanking time and the over-current protection leading edge blanking time;
determining whether noise interference occurs or not according to the first rising slope and the second rising slope;
if the first rising slope is equal to or greater than the short-circuit protection increasing slope threshold, and the second rising slope decreases and is less than the short-circuit protection increasing slope threshold, it is confirmed that noise interference happens, and an exclusion operation for noise interference is performed to continue generating the PWM driving signal;
if the first rising slope and the second rising slope are equal to or greater than the short-circuit protection increasing slope threshold, it is confirmed that short-circuit abnormality occurs, and a short-circuit protection operation is performed to stop generating the PWM driving signal;
if no noise interference occurs and no short-circuit protection operation is performed, a third rising slope of the current sensing voltage at the third detecting time is calculated, wherein the third detecting time is equal to the over-current protection leading edge blanking time, or between the over-current protection leading edge blanking time and the turn-on time, the second rising slope and the third rising slope are subsequently used to determine whether over-current abnormality occurs or not;
if the second rising slope and the third rising slope are equal to or greater than the over-current protection increasing slope threshold, it is confirmed that over-current abnormality occurs, and an over-current protection operation is performed to stop generating the PWM driving signal after an over-current delay time preset; and
if no over-current abnormality occurs, the PWM driving signal is still generated.

7. The power converter controller as claimed in claim 6, wherein the turn-on level is a high level and the turn-off level is a low level lower than the high level.

8. The power converter controller as claimed in claim 6, wherein the turn-on level is a low level and the turn-off level is a high level higher than the high level.

9. The power converter controller as claimed in claim 6, wherein the switch unit is implemented by a Metal-Oxide-Semiconductor (MOS) transistor, a Gallium Nitride field effect transistor (GaN FET), or a silicon carbide (SiC)-MOSFET.
